(19) United States
(12) Patent Application Publication
(10) Pub. No.: US 2012/0286436 A1
(43) Pub. Date: Nov. 15, 2012

(54) TWO-SIDED MICROSTRUCTURE FORMING DEVICE AND METHOD FOR FORMING AN OPTICAL PLATE

(75) Inventors: Hsin-Hung CHEN, Tainan City (TW); Chun-Liang KUO, Tainan City (TW); Chung-Hao WANG, Tainan City (TW)

(73) Assignee: Chi Mei Corporation, Tainan City (TW)

(21) Appl. No.: 13/558,189

(22) Filed: Jul. 25, 2012

Related U.S. Application Data
(63) Continuation-in-part of application No. 13/209,049, filed on Aug. 12, 2011.

(30) Foreign Application Priority Data
Aug. 17, 2010 (TW) 099127425
Apr. 25, 2011 (TW) 100114277
Jul. 29, 2011 (TW) 100127025

(51) Int. Cl. G02B 6/00; B29C 47/06

(52) U.S. Cl. 264/1.24; 425/104

(57) ABSTRACT

A microstructure forming device for forming an optical plate includes: a roller unit including a pressing roller, and first and second embossing rollers that respectively have first and second micropatterned surfaces; an extrusion die for extruding a substrate material to a first nip between the first embossing roller and the pressing roller to form a lower microstructure; and a photosensitive resin-applying unit disposed immediately above the second embossing roller for directing a photosensitive resin onto the second embossing roller to form an upper microstructure that is opposite to the lower microstructure.

### CROSS-REFERENCE TO RELATED APPLICATION

This application claims priority of Taiwanese application no. 100127025, filed on Jul. 29, 2011, and is a continuation-in-part (CIP) of co-pending U.S. patent application Ser. No. 13/209,049, filed on Aug. 12, 2011.

### BACKGROUND OF THE INVENTION

1. Field of the Invention

This invention relates to a method and a device for making an optical plate formed with two-sided microstructures. Especially, with the method and the device of this invention, an optical plate having the two-sided microstructures can be obtained in an in-line coating process and can have a high pattern transfer rate. The optical plate may be, for example, a diffuser, alight guide plate, etc.

2. Description of the Related Art

There are many approaches for forming an optical plate, such as a light guide plate, one of which utilizes an in-line coating process to form the optical plate. The optical plate usually has a microstructure, and the microstructure is usually formed on the optical plate during the in-line coating process. With the development of the optical article or the illuminate article, the optical plate, based on production requirements, may have the microstructure on both sides thereof.

However, the conventional in-line coating process can only form the microstructure on one side of the optical plate. Therefore, if the microstructure has to be formed on two sides of the optical plate, the process should be conducted twice.

### SUMMARY OF THE INVENTION

Therefore, an object of the present invention is to provide a method and a device for making an optical plate formed with two-sided microstructures, which can overcome the aforesaid drawbacks associated with the prior art.

According to the first aspect of this invention, there is provided a device for making an optical plate formed with two-sided microstructures and having lower and upper microstructures respectively on lower and upper surfaces thereof, the device comprising:

a roller unit including a pressing roller, and first and second embossing rollers that respectively have first and second micropatterned surfaces, the first embossing roller cooperating with the pressing roller to define a first nip therebetween and with the second embossing roller to define a second nip therebetween, the second nip being disposed downstream of the first nip;

an extrusion die for extruding a substrate material to the first nip, the substrate material being adapted to be pressed in the first nip to form the lower microstructure that corresponds to the first micropatterned surface; and

a photosensitive resin-applying unit disposed immediately above the second embossing roller for directing a photosensitive resin onto the second micropatterned surface of the second embossing roller, the photosensitive resin being applied to the substrate material and adapted to be pressed in the second nip to form the upper microstructure that corresponds to the second micropatterned surface and that is opposite to the lower microstructure.

According to the second aspect of this invention, there is provided a method for making an optical plate formed with two-sided microstructures and having upper and lower microstructures respectively on upper and lower surfaces thereof, the method comprising:

extruding a substrate material from an extrusion die and advancing the same to pass through a first nip formed between a pressing roller and a first embossing roller having a first micropatterned surface, the first embossing roller being maintained at a temperature higher than that of the pressing roller such that apart of the substrate material that contacts the first embossing roller remains soft, the soft part of the substrate material being pressed by the first embossing roller to form the lower microstructure corresponding to the first micropatterned surface;

advancing the substrate material formed with the lower microstructure to pass through a second nip formed between the first embossing roller and a second embossing roller, the second embossing roller having a second micropatterned surface formed with a plurality of protrusions and a plurality of grooves, the protrusions and the grooves cooperatively defining an upper microstructure-forming space;

applying a photosensitive resin to the second micropatterned surface and filling the same into the upper microstructure-forming space;

allowing the photosensitive resin applied to the second micropatterned surface to pass through the second nip together with the substrate material such that the photosensitive resin is adhered to the substrate material opposite to the lower microstructure and is formed into the upper microstructure corresponding to the second micropatterned surface; and

irradiating and curing the photosensitive resin downstream of the second nip.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic diagram to illustrate the preferred embodiment of a microstructure forming device according to this invention;

FIG. 2 is an enlarged schematic diagram showing a reflector of an irradiating unit of the microstructure forming device shown in FIG. 1;

FIG. 3 is a fragmentary enlarged view of first and second embossing rollers of the microstructure forming device shown in FIG. 1;

FIG. 4 is a fragmentary side view of the first embossing roller of the microstructure forming device shown in FIG. 3;

FIG. 5 is a schematic diagram of the preferred embodiment shown in FIG. 1, which illustrates a pressing roller being shiftable along a circumferential direction of a first embossing roller; and

FIG. 6 is a schematic diagram of the preferred embodiment shown in FIG. 1, which illustrates a second embossing roller being shiftable along a circumferential direction of the first embossing roller.

### DETAILED DESCRIPTION OF THE PREFERRED EMBODIMENTS

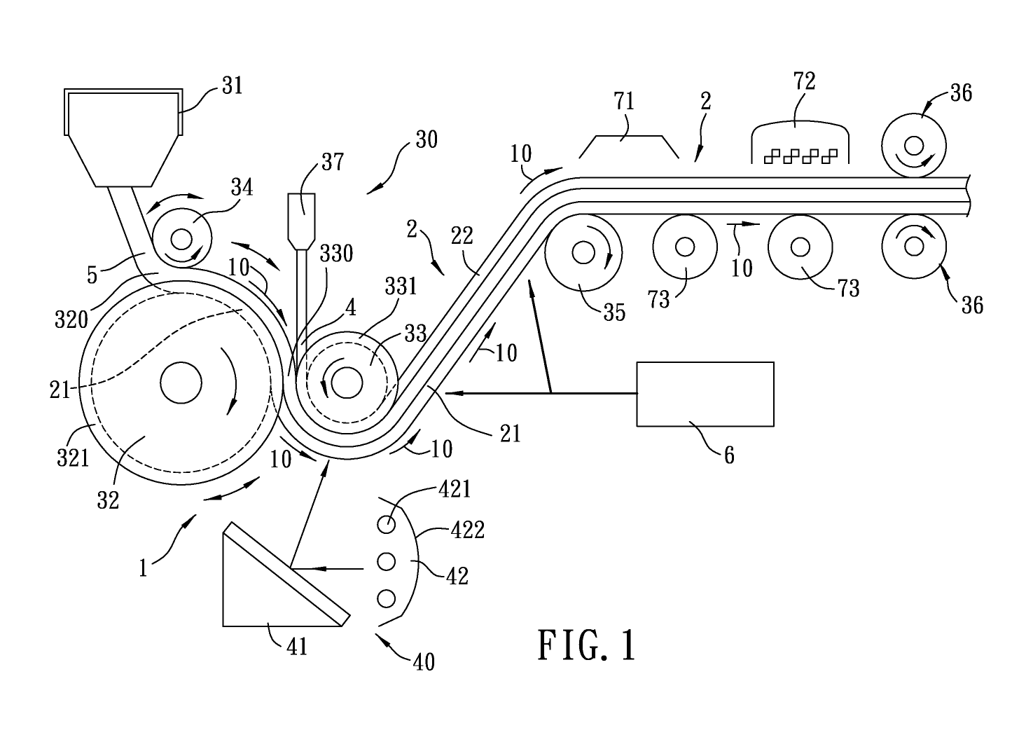

Referring to FIG. 1, a device 1 for making an optical plate 2 is shown. The optical plate 2 is formed with two-sided microstructures, and has lower and upper microstructures 21, 22 respectively on lower and upper surfaces thereof.

The device 1 includes an extrusion die 31 for extruding a substrate material 5 that is adapted to be advanced along a direction indicated by arrows 10, a roller unit 30 that is disposed downstream of the extrusion die 31, a photosensitive resin-applying unit 37 for applying a photosensitive resin 4, an irradiation unit 40, a cooling unit 6, an auxiliary irradiation unit 71, and a heating unit 72.

The roller unit 30 includes first and second embossing rollers 32, 33, a pressing roller 34, a directing roller 35, a pair of drawing rollers 36, and two conveying rollers 73.

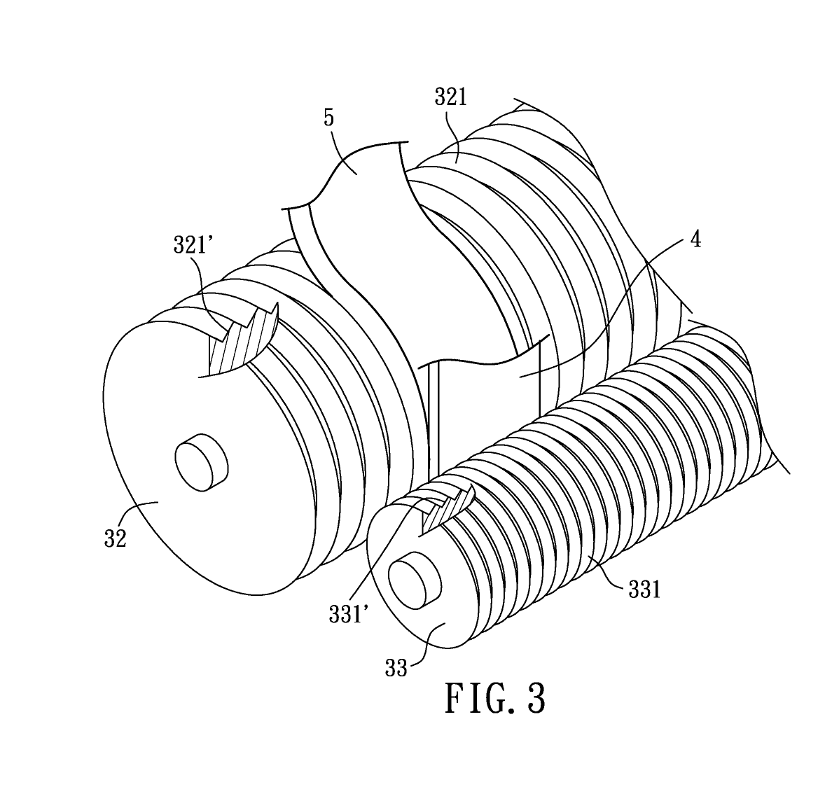

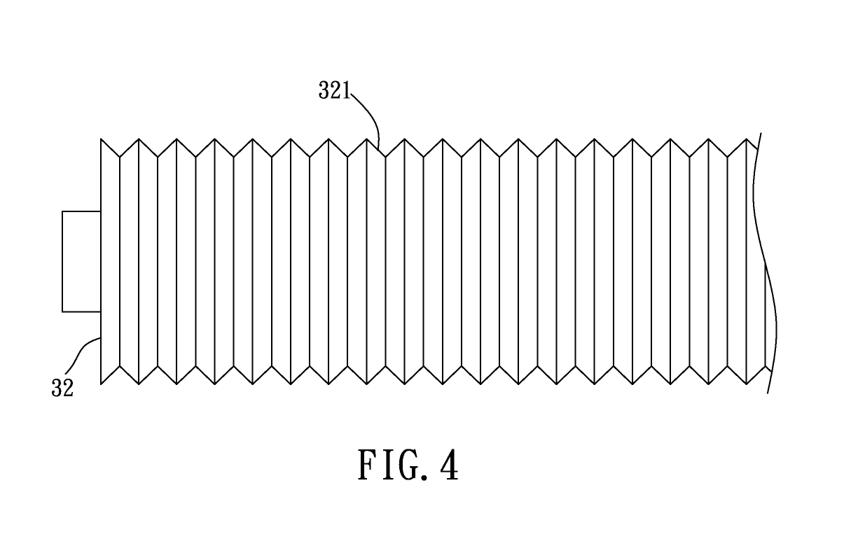

The first and second embossing rollers 32, 33 respectively have first and second micropatterned surfaces 321, 331. The first embossing roller 32 cooperates with the pressing roller 34 to define a first nip 320 therebetween and with the second embossing roller 33 to define a second nip 330 therebetween. The second nip 330 is disposed downstream of the first nip 320. The numerals 321′ and 331′ in FIG. 3 show fragmentary sectional views of the first and second micropatterned surfaces 321, 331 in the preferred embodiment. FIG. 4 shows a side view of the first embossing roller 32 shown in FIG. 3. Each of the first and second micropatterned surfaces 321, 331 has a plurality of annularly extending grooves and annularly extending protrusions arranged alternatingly along an axis of the first or second embossing roller 32 or 33. The grooves and protrusions may be arranged in a spiral form. Alternatively, each of the first and second micropatterned surfaces 321, 331 may have a prism shape, a lenticular shape, etc. The protrusions and grooves of the second micropatterned surface 331 cooperatively define an upper microstructure-forming space.

The substrate material 5 is adapted to be advanced to the first nip 320 and to be pressed in the first nip 320 to form the lower microstructure 21 that corresponds to the first micropatterned surface 321.

The photosensitive resin-applying unit 37 is disposed immediately above the second embossing roller 33 for applying the photosensitive resin 4 to the second micropatterned surface 331 of the second embossing roller and filling the same into the upper microstructure-forming space upstream of the second nip 330 to form a plurality of microelements respectively in the upper microstructure-forming space. The microelements pass through the second nip 330 together with the substrate material 5 such that the microelements of the photosensitive resin 4 are adhered to the substrate material 5 opposite to the lower microstructure 21.

The directing roller 35 is disposed downstream of the second embossing roller 33 such that the substrate material 5 and the photosensitive resin 4 are conveyed along a processing line in a manner of contacting with a lower circumference of the second embossing roller 33. The directing roller 35 is made of a rubber-based material, such as polyurethane rubber.

The drawing rollers 36 are disposed downstream of the directing roller 35.

The pressing roller 34 has a mirror-like surface, and is shiftable along a circumferential direction of the first embossing roller 32 upstream of the second nip 330 to vary a distance between the extrusion die 31 and the first nip 320 and a distance between the first and second nips 320, 330.

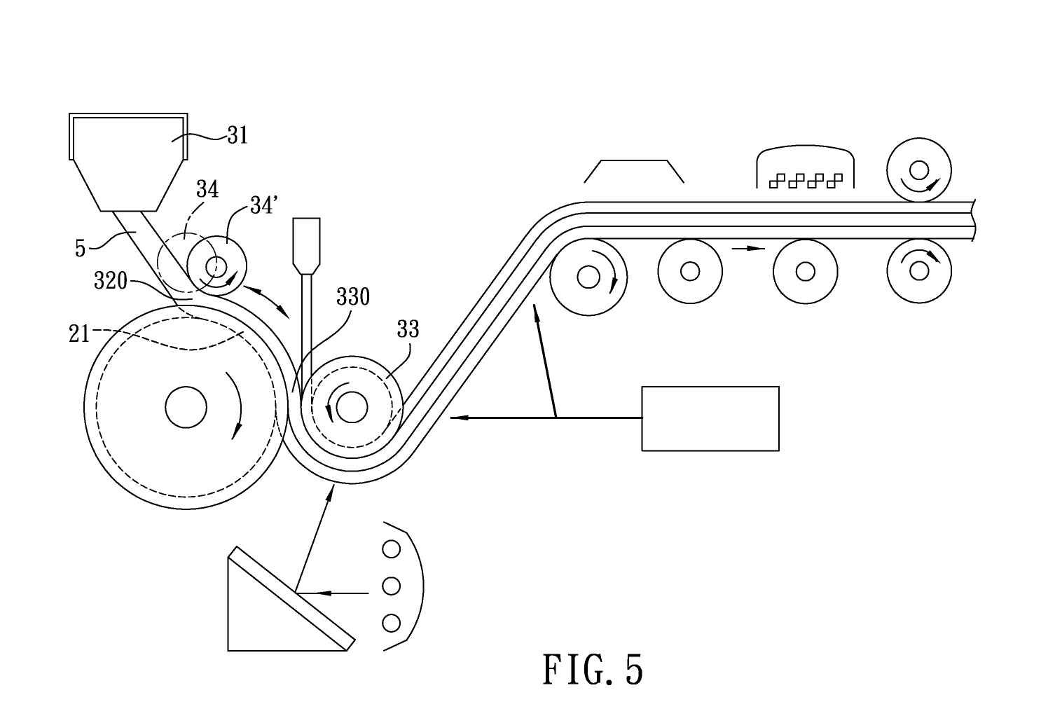

As shown in FIG. 5, the pressing roller 34 is shiftable to a position represented by the numeral 34′. By controlling the position of the pressing roller 34, the substrate material 5 can be control led to have appropriate hardness and will not wrinkle at the surface of the substrate material 5. Because the pressing roller 34 has the mirror-like surface, the substrate material 5 is unlikely to have wrinkles on its upper surface.

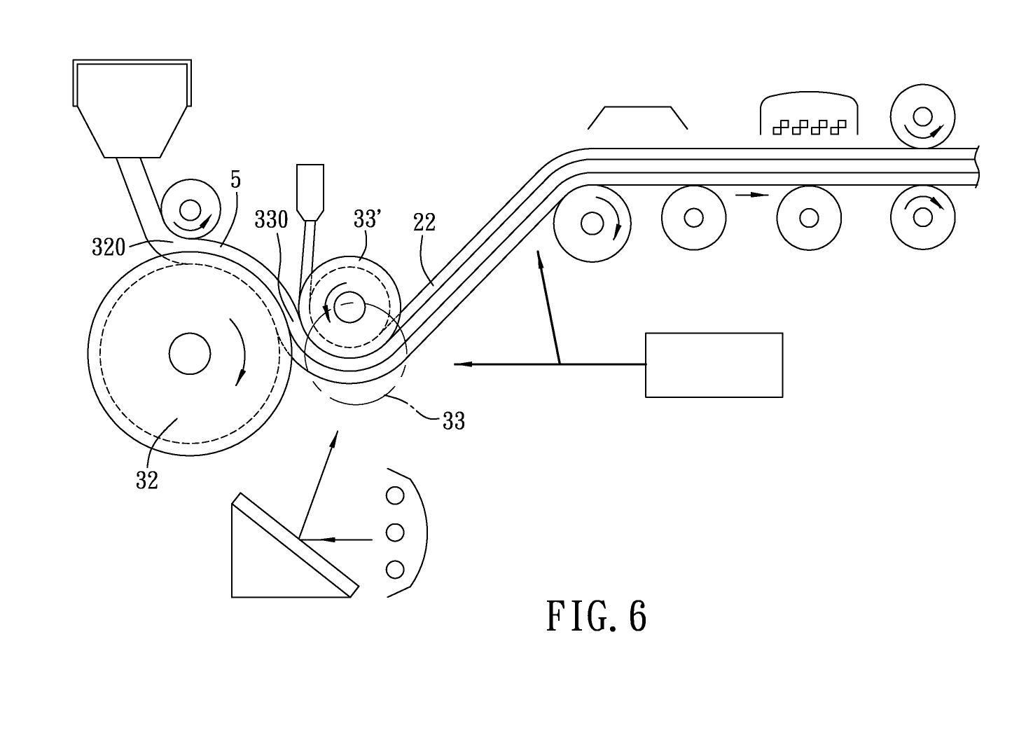

Referring to FIG. 6, the second embossing roller 33 is shiftable along the circumferential direction of the first embossing roller 32 downstream of the first nip 320 to vary the distance between the first and second nips 320, 330. The second embossing roller 33 is shiftable to a position represented by the numeral 33′.

Besides, a distance between the extrusion die 31 and the first nip 320 can also be adjusted by shifting the extrusion die 31 along a circumferential direction of the pressing roller 34. As such, a contact area of the substrate material 5 with the pressing roller 34 before being advanced into the first nip 320 can be adjusted so as to adjust upper and lower surface temperatures of the substrate material 5.

The irradiation unit 40 is disposed below a lower part of the second embossing roller 33 and downstream of the second nip 330 to irradiate and cure the photosensitive resin 4. The irradiation unit 40 includes an irradiating member 42 for emitting light and a reflector 41 for reflecting the light from the irradiating member 42 toward the second embossing roller 33. If the irradiating member 42 is disposed directly under the second embossing roller 33, the photosensitive resin 4 might fall on the irradiating member 42, which is hard to clean and would reduced the light-emitting efficiency of the irradiating member 42, thereby reducing the pattern transfer rate of the microstructures. With the reflector 41, the light emitted from the irradiating member 42 can be reflected to travel upwardly (see FIG. 1), and can be disposed at a position not directly under the second embossing roller 33 to prevent the photosensitive resin 4 from dripping on the irradiating member 42.

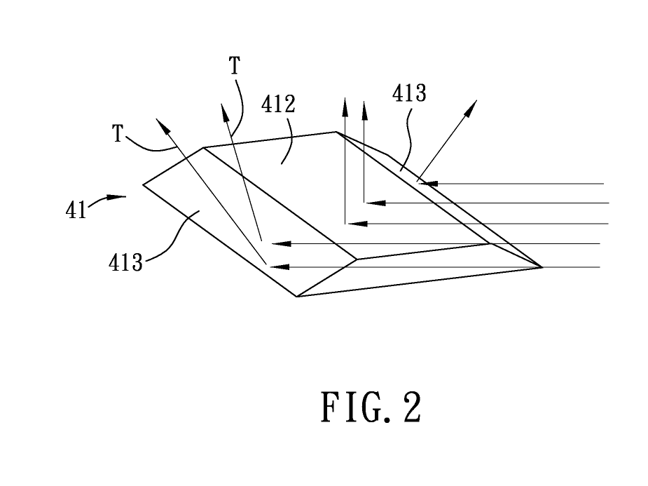

Referring to FIG. 2, an exemplary reflector 41 of the irradiation unit 40 includes a middle reflecting surface 412 facing and inclined to the irradiating member 42, and two side reflecting surfaces 413 respectively connected to two opposite edges of the middle reflecting surface 412 and inclined at an angle ranging from 0 to 30 degrees with respect to the middle reflecting surface 412. In this embodiment, the middle surface 412 is inclined at an angle such that the same may directly reflect the light from the irradiating member 42 to the second embossing roller 33. At the same time, the side reflecting surfaces 413 may reflect the light to different directions, such as the arrow represented by “T,” so as to broaden the irradiation range of the light, thereby improving the irradiation efficiency of the irradiation unit 40. Alternatively, the reflector 41 may have a triangular structure, a round structure, etc.

In this embodiment, the irradiating member 42 is disposed on one side of the reflector 41 for supplying UV light, and includes a plurality of UV lamps 421 and a reflecting cover 422 that has a curve-shape for directing the UV light to evenly travel toward the reflector 41. With the irradiation unit 40, the photoresist resin 4 can be cured on the substrate material 5 so as to obtain the optical plate 2.

Although the photosensitive resin 4 on the substrate material 5 is irradiated by the irradiation unit 40, the lower and upper microstructures 21, 22 of the optical plate 2 are not cured completely. The cooling unit 6 is thus provided to be disposed downstream of the second embossing roller 33 and upstream of the directing roller for cooling the substrate material 5 and the photosensitive resin 4 after being irradiated by the irradiation unit 40. In detail, cooling air from the cooling unit 6 is delivered to the optical plate 2, thereby instantaneously curing the lower and upper microstructures 21, 22 of the optical plate 2, and thereby preventing deformation of the lower and upper microstructures 21, 22 upon contacting with the rollers in the subsequent processing line.

The auxiliary irradiation unit 71 is disposed downstream of the directing roller 35 and upstream of the drawing rollers 36 for further curing the photosensitive resin 4. The heating unit 72 is disposed downstream of the directing roller 35 and upstream of the drawing rollers 36. The conveying rollers 73 are disposed downstream of the directing roller 35 and upstream of the drawing rollers 36 for evenly conveying the optical plate 2. Each of the conveying rollers 73 has a relatively hard roller surface.

The preferred embodiment of a method for making the optical plate 2 according to this invention includes the following steps.

In an extruding step, the substrate material 5 is extruded from the extrusion die 31 in a molten state. Preferably, the substrate material 5 is extruded at a temperature ranging from 150° C. to 300° C. The preferred extruding temperature ranges from 170° C. to 260° C. The extruding speed of the extrusion die 31 is determined based on the thickness of the optical plate 2.

Preferably, the substrate material 5 is an optical resin material that has specific optical properties and is suitable for making an optical plate. Examples of the substrate material 5 include, but are not limited to, (meth)acrylic resin, polycarbonate resin (PC resin), polystyrene resin (PS resin), methyl methacrylate-styrene copolymer (MS resin), acrylonitrile-styrene copolymer (AS resin), cyclic olefin polymers (COC resin), and polyethylene terephthalate (PETG resin).

The aforesaid (meth)arylic resin is acylic resin and/or methacrylic resin (e.g., poly methyl methacrylate (PMMA) resin), and is formed from (meth)acrylate monomers (i.e., acrylate monomers and/or methacrylate monomers) such as methyl methacrylate, ethyl methacrylate, methyl isopropyl methacrylate, n-butylacrylate, methacrylate, ethyl acrylate, isopropyl acrylate, etc. Preferably, the (meth)acrylic resin is formed from methyl methacrylate and methacrylate.

Additionally, the substrate material 5 may include an additive such as a light diffusion agent, a fluorescent agent, an UV absorber and an antioxidant. The light diffusion agent may be inorganic microparticles made from, e.g., barium sulfate (BaSO₄) or titanium dioxide (TiO₂), or organic particles made from, e.g., polystyrene resin, (meth)acrylic resin, or polyorganosiloxane resin.

In this embodiment, the substrate material 5 is poly methyl methacrylate (PMMA) and has a glass transition temperature (T_{g}) of about 118° C.

In a lower microstructure forming step, the substrate material 5 is advanced to pass through the first nip 320 at a temperature ranging from the glass transition temperature (T_{g}) of the substrate material 5 to T_{g}+100° C. such that the substrate material 5 is soft and can be adhered to the first embossing roller 32. The first embossing roller 32 is maintained at a temperature higher than that of the pressing roller 34 such that a part of the substrate material 5 that contacts the first embossing roller 32 remains soft, and thus, before passing through the second nip 330, the substrate material 5 can come into contact with the first embossing roller 32. The soft part of the substrate material 5 is pressed by the pressing roller 34 and the first embossing roller 32 at the first nip 320, thereby forming the lower microstructure 21 corresponding to the first micropatterned surface 321. Preferably, the temperature of the first embossing roller 32 ranges from 95° C. to 110° C., and the temperature of the pressing roller 34 ranges from 70° C. to 80° C. Besides, in this step, an upper surface of the substrate material 5 that is opposite to the lower microstructure 21 is leveled by rolling of the pressing roller 34 such that the photosensitive resin 4 can be evenly formed on the substrate material 5 in the next step. As such, with the pressing roller 4, the uniformity and the pattern transfer rate of the upper microstructure can be enhanced.

In an upper microstructure forming step, the substrate material 5 formed with the lower microstructure 21 is advanced to pass through the second nip 330 formed between the first embossing roller 32 and the second embossing roller 33. The photosensitive resin 4 is applied to the second micropatterned surface 331 and is filled into the upper microstructure-forming space so as to form the microelements. The photosensitive resin 4 applied to the second micropatterned surface 331 is allowed to pass through the second nip 330 together with the substrate material 5 such that the microelements of the photosensitive resin 4 are adhered to the substrate material 5 opposite to the lower microstructure 21, thereby forming the upper microstructure 22 corresponding to the second micropatterned surface 331.

When passing through the second nip 330, the substrate material 5 should be maintained at a relatively high temperature to have flexibility. If the temperature of the first or second embossing roller 32 or 33 is too low, the substrate material 5 may become hard and is likely to crack. On the other hand, if the temperature of the first or second embossing roller 32 or 33 is too high, the substrate material 5 may have undesirably high flowability which adversely affects formation of the lower and upper microstructures 21, 22.

It should be noted that, when the photosensitive resin 4 and the substrate material 5 pass through the second nip 330, the same are forced by the first and second embossing rollers 32, 33 such that the substrate material is likely to slightly protrude into the microstructure-forming space and thus to force the photosensitive resin 4 filled in the microstructure-forming space, thereby further facilitating formation of a complete shape of the micropattern for the microelements.

The photosensitive resin 4 can be directed to the second micropatterned surface 331 of the second embossing roller 33 by, for example, spraying or extruding. Besides, in order to evenly inject the photosensitive resin 4 into the upper microstructure-forming space, the photosensitive resin 4 is fed to the second embossing roller 33 at an adequate speed. If the speed is too high, the photosensitive resin 4 cannot evenly flow into the upper microstructure-forming space. If the speed is too low, the photosensitive resin 4 cannot be fully filled in the upper microstructure-forming space. Preferably, the flowing speed of the photosensitive resin 4 ranges from 50 cm³/min·m to 1200 cm³/min·m. The unit of cm³/min·m is the applied amount per unit of time and per unit of plate width, in which plate width indicates the width of the applied photosensitive resin 4.

The photosensitive resin 4 should have a property of high fluidity to flow into the upper microstructure-forming space defined by the protrusions and grooves of the second micropatterned surface 331. Besides, the photosensitive resin 4 should further have a property of high photosensitivity. This is because the rollers of the roller unit 30 are rotated at a constant speed to convey the substrate material 5 and the photosensitive resin 4, and the photosensitive resin 4 should be rapidly cured by radiation of light through induced cross-linking reaction in harmony with the speed of the rollers, such that the processing speed of the device 1 would not be lowered down due to the curing step of the photosensitive resin 4. For example, the photosensitive resin 4 may be an ultraviolet (UV) photosensitive resin, an infrared (IR) photosensitive resin, or a halogen photosensitive resin. In the preferred embodiment of this invention, the photosensitive resin 4 is an ultraviolet photosensitive resin that includes, e.g., (a) an acrylic resin present in a range from 40 wt % to 50 wt % based on 100 wt % ultraviolet photosensitive resin, (b) a free radical photo-initiator present in a range from 5 wt % to 15 wt % based on 100 wt % ultraviolet photosensitive resin, and (c) a reactive acrylic cross-linking resin present in a range from 40 wt % to 50 wt % based on 100 wt % ultraviolet photosensitive resin. Examples of the free radical photo-initiator include trimethyl benzoyl phosphine oxide (TPO), 2-methyl-1-[4-(methylthio)phenyl]-2-morpholino propan-1-one (e.g., Ciba Irgacure 907), isothioxanthone (ITX) and combinations thereof. Examples of the reactive acrylic cross-linking resin include di-trimethylolpropane tetraacrylate (e.g., SR-355), dipentaerythritol monohydroxy pentaacrylate (e.g., SR-399), ethoxylated bisphenol A diacrylate (e.g., SR-349), and combinations thereof.

In an irradiating step, the photosensitive resin 4 downstream of the second nip 330 is irradiated and cured by the irradiating unit 40. The irradiating member 42 may emit ultraviolent light, infrared light or halogen light based on the chosen material of the photosensitive resin 4. Preferably, the irradiating member 42 has an optical power ranging from 100 W/cm to 1,000 W/cm. In this embodiment, the optical power of the irradiating member 42 is about 240 watts/cm.

Then, the photosensitive resin 4 and the substrate material 5 are directed along the processing line in a manner of contacting with a lower circumference of the second embossing roller 33 by using the directing roller 35 disposed downstream of the second embossing roller 33. The substrate material 5 and the photosensitive resin 4 disposed between the second embossing roller 33 and the directing roller 35 are cooled to form the optical plate 2. The optical plate 2 is then advanced to pass through the auxiliary irradiation unit 71 and the heating unit 72.

The method may further include a step of shifting the pressing roller 34 along the circumferential direction of the first embossing roller 32 to set a distance between the first nip 320 and the extrusion die 31 (see FIG. 5). The substrate material 5 that contacts the pressing roller 34 has a flat surface. If the substrate material 5 contacts the pressing roller 34 at an early time, the substrate material 5 may be cured before advancing to the first nip 320 since the pressing roller 34 has a relatively low temperature. In this case, the lower microstructure 21 of the optical plate 2 cannot be formed. If the substrate material 5 contacts the pressing roller 34 at a later time, the distance between the first and second nips 320, 330 will be reduced, which adversely affects formation of the lower microstructure 21 of the optical plate 2. After setting the position of the pressing roller 34, the second embossing roller 33 can be also shifted to adjust the distance between the first and second nips 320, 330. If the distance between the first and second nips 320, 330 is too long, the temperature of the first embossing roller 32 should be higher. On the contrary, if the distance between the first and second nips 320, 330 is too short, the temperature of the first embossing roller 32 should be lower. This is because the substrate material 5 should have adequate softness such that the upper microstructure 22 can be formed thereon.

The optical plate 2 may be a diffuser, a light guide plate, etc., and has a thickness ranging preferably from 0.1 mm to 10 mm, more preferably from 0.2 mm to 8 mm, and most preferably from 0.3 mm to 6 mm. The thickness of the optical plate 2 can be controlled by the extruding speed of the substrate material 5, the width of the first nip 330, the rotating speed of the first embossing roller 32, etc.

In the case of each of the first and second micropatterned surfaces 321, 331 having a prism shape that can collect light, the refractive index difference between the photosensitive resin 4 and the substrate material 5 is preferably not greater than 0.05, more preferably not greater than 0.03, and most preferably not greater than 0.01. On the other hand, when the optical plate 2 is used to diffuse light, the refractive index difference between the photosensitive resin 4 and the substrate material 5 can be greater.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A device for making an optical plate formed with two-sided microstructures and having lower and upper microstructures respectively on lower and upper surfaces thereof, said device comprising:
a roller unit including a pressing roller, and first and second embossing rollers that respectively have first and second micropatterned surfaces, said first embossing roller cooperating with said pressing roller to define a first nip therebetween and with said second embossing roller to define a second nip therebetween, said second nip being disposed downstream of said first nip;
an extrusion die for extruding a substrate material to said first nip, the substrate material being adapted to be pressed in said first nip to form the lower microstructure that corresponds to said first micropatterned surface; and
a photosensitive resin-applying unit disposed immediately above said second embossing roller for directing a photosensitive resin onto said second micropatterned surface of said second embossing roller, the photosensitive resin being applied to the substrate material and adapted to be pressed in said second nip to form the upper microstructure that corresponds to said second micropatterned surface and that is opposite to the lower microstructure.

2. The device of claim 1, further comprising:
an irradiation unit disposed below a lower part of said second embossing roller and downstream of said second nip to irradiate and cure the photosensitive resin.

3. The device of claim 2, wherein said irradiation unit includes an irradiating member for emitting light, and a reflector for reflecting the light from said irradiating member toward said second embossing roller.

4. The device of claim 2, wherein said roller unit further comprises:
a directing roller disposed downstream of said second embossing roller such that the substrate material and the photosensitive resin are conveyed along a processing line in a manner of contacting with a lower circumference of said second embossing roller; and
a drawing roller disposed downstream of said directing roller.

5. The device of claim 4, further comprising:
a cooling unit disposed downstream of said second embossing roller and upstream of said directing roller for cooling the substrate material and the photosensitive resin after irradiation by said irradiation unit.

6. The device of claim 4, further comprising:
a heating unit disposed downstream of said directing roller and upstream of said drawing roller.

7. The device of claim 4, further comprising:
an auxiliary irradiation unit disposed downstream of said directing roller and upstream of said drawing roller.

8. The device of claim 4, wherein said roller unit further comprises:
a conveying roller disposed downstream of said directing roller and upstream of said drawing roller for evenly conveying the optical plate.

9. The device of claim 4, wherein said directing roller is made of a rubber-based material.

10. The device of claim 1, wherein said pressing roller has a mirror-like surface, and is shiftable along a circumferential direction of said first embossing roller upstream of said second nip to vary a distance between said extruder and said first nip and a distance between said first and second nips.

11. The device of claim 1, wherein said second embossing roller is shiftable along a circumferential direction of said first embossing roller downstream of said first nip to vary a distance between said first and second nips.

12. The device of claim 1, which is adapted to form the optical plate with a thickness ranging from 0.3 mm to 6 mm.

13. A method for making an optical plate formed with two-sided microstructures and having upper and lower microstructures respectively on upper and lower surfaces thereof, the method comprising:
extruding a substrate material from an extrusion die and advancing the same to pass through a first nip formed between a pressing roller and a first embossing roller having a first micropatterned surface, the first embossing roller being maintained at a temperature higher than that of the pressing roller such that apart of the substrate material that contacts the first embossing roller remains soft, the soft part of the substrate material being pressed by the first embossing roller to form the lower microstructure corresponding to the first micropatterned surface;
advancing the substrate material formed with the lower microstructure to pass through a second nip formed between the first embossing roller and a second embossing roller, the second embossing roller having a second micropatterned surface formed with a plurality of protrusions and a plurality of grooves, the protrusions and the grooves cooperatively defining an upper microstructure-forming space;
applying a photosensitive resin to the second micropatterned surface and filling the same into the upper microstructure-forming space;
allowing the photosensitive resin applied to the second micropatterned surface to pass through the second nip together with the substrate material such that the photosensitive resin is adhered to the substrate material opposite to the lower microstructure and is formed into the upper microstructure corresponding to the second micropatterned surface; and
irradiating and curing the photosensitive resin downstream of the second nip.

14. The method of claim 13, wherein the substrate material is extruded at a temperature ranging from 150° C. to 300° C., the temperature of the first embossing roller ranges from 95° C. to 110° C., and the temperature of the pressing roller ranges from 70° C. to 80° C.

15. The method of claim 13, further comprising:
directing the photosensitive resin and the substrate material along a processing line in a manner of contacting with a lower circumference of the second embossing roller using a directing roller disposed downstream of the second embossing roller; and
cooling the substrate material and the photosensitive resin disposed between the second embossing roller and the directing roller to form the optical plate.

16. The method of claim 13, wherein the pressing roller has a mirror-like surface, the method further comprising:
shifting the pressing roller along a circumferential direction of the first embossing roller upstream of the second nip to vary a distance between the extruder and the first nip and a distance between the first and second nips.

17. The method of claim 13, further comprising:
shifting the second embossing roller along a circumferential direction of the first embossing roller downstream of the first nip to vary a distance between the first and second nips.

18. The method of claim 13, further comprising:
shifting the pressing roller along a circumferential direction of the first embossing roller upstream of the second nip to set a distance between the first nip and the extruder, and shifting the second embossing roller along the circumferential direction of the first embossing roller downstream of the first nip to set a distance between the first and second nips.
